(19) United States
(12) Patent Application Publication
(10) Pub. No.: US 2004/0202865 A1
(43) Pub. Date: Oct. 14, 2004

(54) Release coating for stamper

(76) Inventors: Andrew Homola, Morgan Hill, CA (US); Shaun H. Chen, Cupertino, CA (US)

Correspondence Address: Daniel E. Ovanezian, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/409,902

(22) Filed: Apr. 8, 2003

(51) Int. Cl. B29C 43/02

(52) U.S. Cl. 428/421; 425/134; 425/810; 425/406

(57) ABSTRACT

A stamper having a perfluoropolyether coating.

### TECHNICAL FIELD

Embodiments of this invention relate to the field of manufacturing and, more specifically, to the manufacture of a disk stamper.

### BACKGROUND

A disk drive system includes one or more magnetic recording disks and control mechanisms for storing data on the disks. The disks are constructed of a substrate, that may be textured, and multiple film layers. In most systems, an aluminum based substrate is used. However, alternative substrate materials such as glass have various performance benefits such that it may be desirable to use a glass substrate. One of the film layers on a recording disk is a magnetic layer used to store data. The reading and writing of data is accomplished by flying a read-write head over the disk to alter the properties of the disk's magnetic layer. The read-write head is typically a part of or affixed to a larger body that flies over the disk, referred to as a slider.

The trend in the design of disk drives is to increase the recording density of the drive system. One method for increasing recording densities is to pattern the surface of the disk to form discrete data tracks, referred to as discrete track recording (DTR). DTR disks typically have a series of concentric raised zones (a.k.a. hills, lands, elevations, etc.) storing data and recessed zones (a.k.a. troughs, valleys, grooves, etc.) that provide inter-track isolation to reduce noise. Such recessed zones may also store servo information. The recessed zones separate the raised zones to inhibit or prevent the unintended storage of data in the recessed zones.

One method of producing DTR magnetic recording disks is through nano imprint lithography (NIL) techniques. NIL involves the use of a pre-embossed rigid forming tool (a.k.a. stamper, embosser, etc.) having an inverse (negative replica) of a DTR pattern. The stamper is pressed onto a thin layer of polymer on the disk. The coupled stamper and disk are often heated and then the stamper is removed leaving an imprint of the DTR pattern on the polymer layer.

A problem with current NIL techniques is that polymeric material may be transferred from the disk's polymer layer onto the stamper when the stamper is separated from the disk. The transferred polymeric material then resides as asperities on the stamper that may ultimately be transferred to the embossable layer of a subsequently stamped disk as defects (e.g., pits and hills) during imprinting. Any asperity pits, if sufficiently large, may undesirably interfere with the generation of a desired track pattern and any asperity hills may interfere with the operation of the disk by not enabling sufficient glide height of the head over the disk surface. In order to produce the extremely fine patterns needed to get high sensitivity and reproduce identical nano-structures from a master stamper in mass volume, minimal (ideally zero) transfer of polymeric material asperities from the disk's polymer layer onto the stamper is required.

A prior art method of providing a stamper with a wear resistant release coating involves the polymerization of a fluorine compound after its application to the stamper. The fluorine compound is provided in gaseous form and plasma polymerized on the stamper's surface during application.

### BRIEF DESCRIPTION OF THE DRAWINGS

The present invention is illustrated by way of example, and not limitation, in the figures of the accompanying drawings in which:

FIG. 1A illustrates one embodiment of a stamper body coated with a fluorine polymer.

FIG. 1B illustrates an alternative embodiment of stamper having multiple coating layers.

FIG. 2A illustrates the chemical structure of a difunctional perfluoropolyether molecule having carboxyl polar groups.

FIG. 2B illustrates the chemical structure for Z-Dol.

FIG. 2C illustrates the chemical structure for AM3001.

FIG. 2D illustrates the chemical structure for ZTetraol.

FIG. 2E illustrates the chemical structure for Moresco.

FIG. 3 illustrates one embodiment of a method of producing a stamper having a fluorine polymer coating.

### DETAILED DESCRIPTION

In the following description, numerous specific details are set forth such as examples of specific materials or components in order to provide a thorough understanding of the present invention. It will be apparent, however, to one skilled in the art that these specific details need not be employed to practice the invention. In other instances, well known components or methods have not been described in detail in order to avoid unnecessarily obscuring the present invention.

The terms “above” and “on” as used herein refer to a relative position of one layer with respect to other layers. As such, one layer deposited above or on another layer may be directly in contact with the other layer or may have one or more intervening layers.

It should be noted that the apparatus and methods discussed herein may be used with various types of disks. In one embodiment, for example, the apparatus and methods discussed herein may be used with a magnetic recording disk. Alternatively, the apparatus and methods discussed herein may be used with other types of digital recording disks, for example, optical recording disks such as a compact disc (CD) and a digital-versatile-disk (DVD).

An embossing tool, or stamper, may be used to create a discrete track pattern on a disk. The stamper is coated with a thin polymer film. In one embodiment, the stamper is coated with perfluoropolyether polymers. The coated stamper may exhibit a low friction and a low energy surface that facilitates surface separation between the stamper and a disk's embossable layer (e.g., a polymer) without significant transfer of embossable layer (e.g., polymeric) material onto the stamper. In addition, the perfluoropolyether coating on the stamper may also exhibit high temperature resistance enabling repeated imprints of embossable films at elevated temperatures with effective surface separation without significant material transfer.

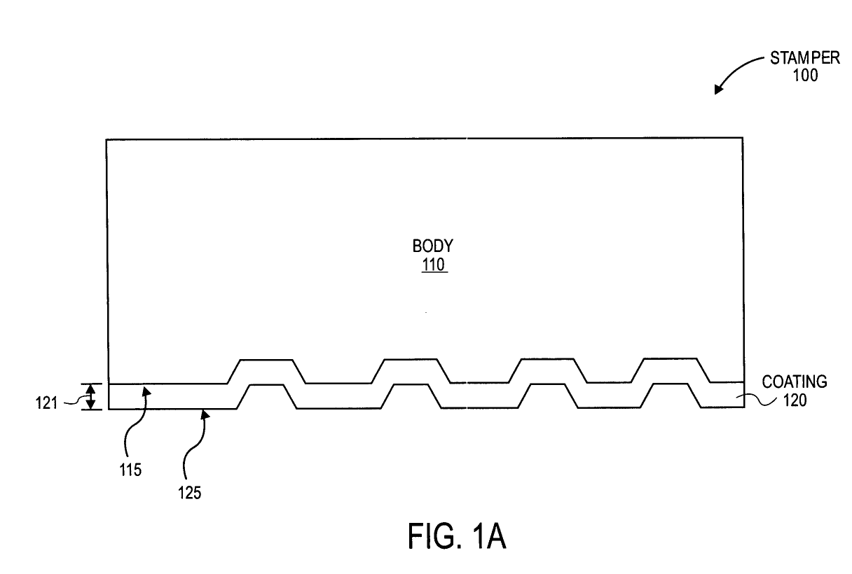

FIG. 1A illustrates one embodiment of a stamper body coated with a fluorine polymer. In one embodiment, the stamper body 110 is composed of a nickel phosphorous (NiP) metal alloy. Alternatively, other metal alloys or metals, for examples, nickel, chromium, and copper may be used for stamper body 110. In another embodiment, other rigid materials may be used for the stamper body 110, for examples, glass and ceramic. The stamper body 110 may have a patterned surface 115 that is an inverse of a discrete track pattern to be imprinted on an embossable layer of a disk. The generation of a patterned stamper is known in the art; accordingly, a detailed discussion is not provided. Alternatively, the stamper body 110 may not have a patterned surface.

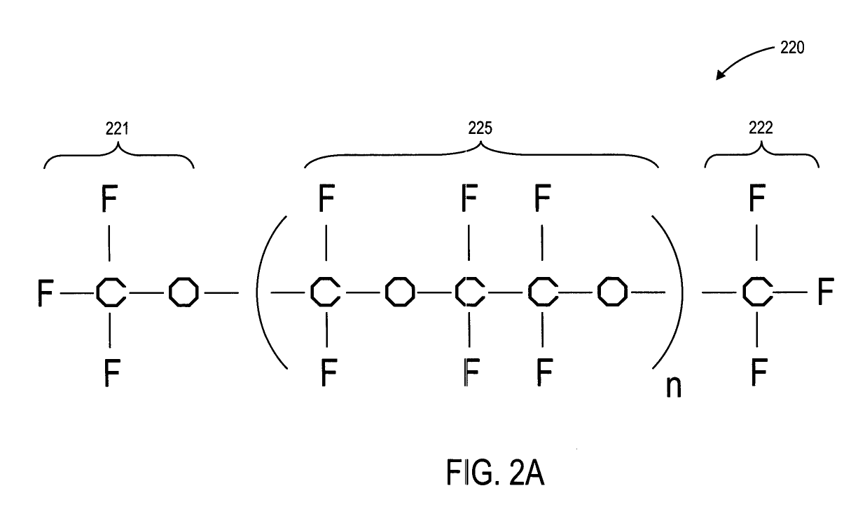

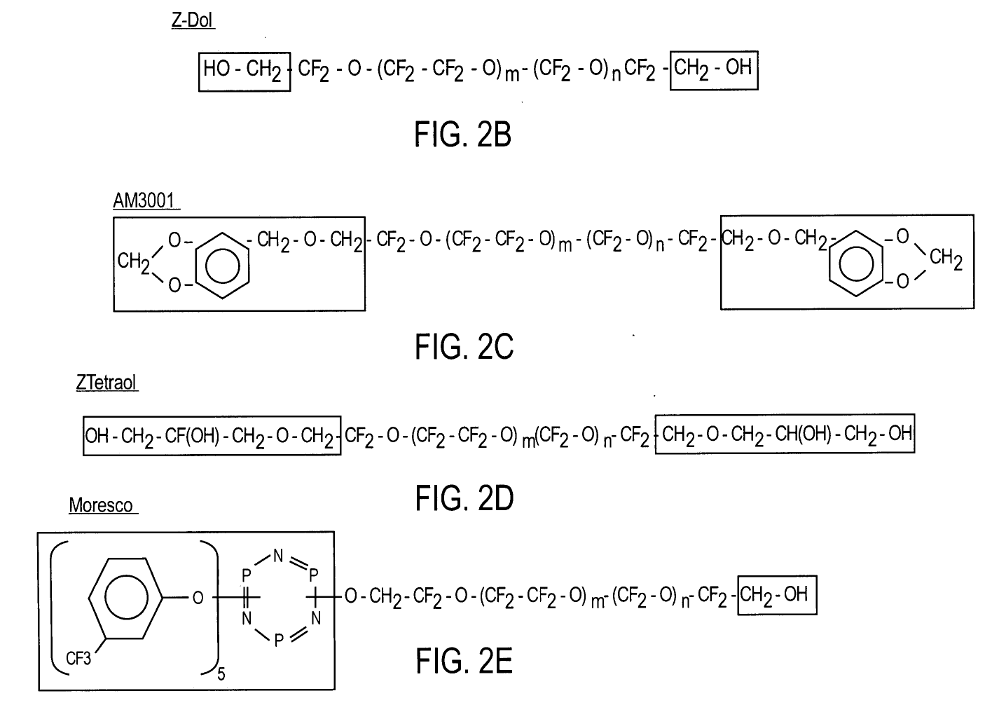

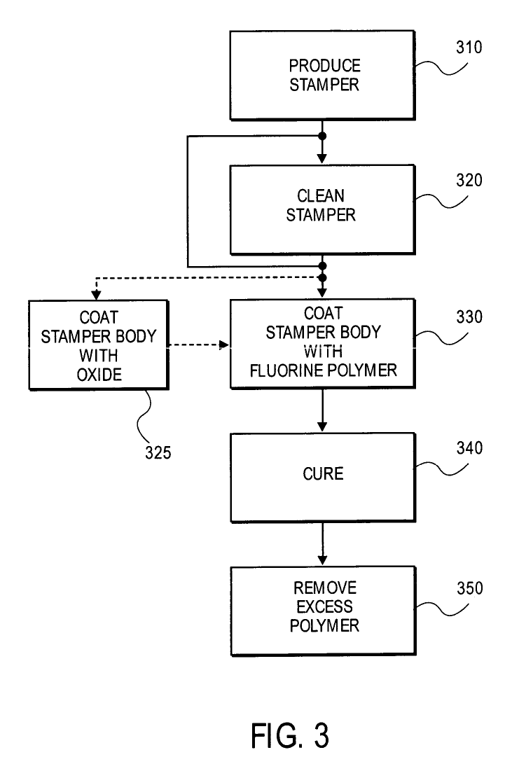

In one embodiment, the polymer coating 120 contains functional perfluoropolyether molecules that are terminated by a single polar group, for examples, hydroxyl, carboxyl or amine. In an alternative embodiment, the polymer coating 120 contains difunctional perfluoropolyether compounds having polar groups on both ends of the molecules. The chemical structure for difunctional perfluoropolyether molecule 220 having carboxyl polar groups 221 and 222 is illustrated in FIG. 2A. Functional and difunctional perfluoropolyether compounds are capable of forming strong covalent bonds with the surface of metal or metal alloy stamper. The polar groups (e.g., group 221 or 222) react with the surface (e.g., surface 115) of the stamper's body 110 and fluorinated polymer chain 225 orients away towards the air/polymer interface. In one embodiment, commercial perfluoropolyether having the trade name Z-Dol (M. Wt. 2000) with hydroxyl terminal end group may be used. The chemical structure for Z-Dol is illustrated in FIG. 2B. Z-Dol is available from Ausimont of Italy. Alternatively, other perfluoropolyethers may be used, for examples, AM3001, Z-Tetraol and Moresco compounds. The chemical structures of AM3001, Z-Tetraol and Moresco are illustrated in FIGS. 2C, 2D and 2E, respectively. The coated stamper 110 may be produced as discussed below in relation to FIG. 3.

FIG. 1B illustrates an alternative embodiment of stamper having multiple coating layers. An oxide layer 130, for example, SiO₂ may be disposed between body 110 and coating 120. In one embodiment, for example, oxide layer 130 has a thickness 131 in the approximate range of 5 to 50 Angstroms. Alternatively, oxide layer 130 may have a thickness 131 outside this range. Oxide layer 130 may reduce the catalytic effect of a Ni surface body 110 by isolating the fluorocarbons from the Ni surface. Oxide layer 130 may also provide good adhesion of coating 120. For example, where a perfluoropolyether molecule with hydroxyl groups is used, oxide layer 130 may provide anchoring sites for the mostly hydroxyl groups of the fluorinate molecules. In an alternative embodiment, other oxides may be used for layer 130, for example, TiO₂. Oxide layer 130 may be formed using techniques known in the art, for examples, sputtering and chemical vapor deposition.

FIG. 3 illustrates one embodiment of a method of producing a stamper having a fluorine polymer coating. A stamper having a body 110 is provided in step 310. The manufacture of a stamper body is known in the art; accordingly, a detailed discussion is not provided. The stamper body 110 may then coated with a fluorine polymer, step 330. In one embodiment, prior to application of the polymer coating 120, the stamper body 110 may be cleaned as illustrated by step 320. The stamper body 110 may be cleaned in a plasma (e.g., oxygen or hydrogen plasma) to remove any absorbed organic contaminants that may hinder attachment of the polar groups to the surface of stamper body 110. In another embodiment, other cleaning methods known in the art may be used to clean stamper body 110. The effect of cleaning process can be monitored by measuring contact angle of water on the cleaned surface that should be close to zero for effectiveness. Alternatively, no cleaning of stamper body 110 need be performed.

In one embodiment, the surface 115 of stamper body 110 may be coated with an oxide, step 325. The oxide may be deposited on the surface 115 using techniques known in the art. Alternatively, an oxide layer need not be deposited on stamper body 110.

Next, the surface 115 of stamper body 110 is coated with a fluorine polymer compound (e.g., perfluoropolyether), step 330. In one embodiment, the fluorine compound is polymerized prior to its application on surface 115. The fluorine polymer compound may be applied, for example, in liquid form by placing a few drops of neat liquid perfluoropolyether compound at one or more locations on the surface 115 and then distributing the liquid uniformly over the entire surface 115 of stamper body 110. Alternatively, the stamper's surface may be coated using other techniques, for examples, dip-coating, spin-coating, and chemical vapor deposition (CVD).

Next, coating 120 on the stamper 100 is cured, step 340. In one embodiment, curing may be performed by heating stamper 100 to expose the coated 120 surface 115 to an elevated temperature for some duration. Heating may be performed to effect a strong attachment between coating 120 and surface 115 of stamper body 110. For example, where a metal/metal alloy stamper body 110 is used with a coating 120 of perfluoropolyether (Z-DOL, M. Wt. 2000) having a hydroxyl terminal end group, heat curing may effect a strong attachment between the Z-DOL molecules in coating 120 and the metal surface 115. In one embodiment, the curing may be formed in the range of approximately 100 to 250 degrees Centigrade (C). In one embodiment, the curing exposure time may in the range of approximately 15 minutes to 1 hour. In other embodiments, other temperatures and exposure times may be used. Following heating, the stamper may be cooled to room temperature. Alternatively, coating 120 may be cured without heating, for example, by waiting for the fluorine polymer compound to solidify at approximately the same temperature it was applied such as room temperature.

Then, in step 350, an excess of unattached fluorine polymer may be removed, for example, by rinsing with a fluorinated solvent. Alternatively, removal of unattached polymer need not be performed.

Referring again to FIG. 1A, the thickness 121 of the attached coating 120, in one embodiment, may be in the range of approximately 10 to 25 Angstroms (A). In alternative embodiments, coating 120 has another thickness 121 that, for example, may depend on selected temperature and exposure time of curing.

The coated stamper 100 may exhibit a low function and a low energy coated surface 125 that facilitates surface separation between the stamper 100 and a disk's embossable layer (e.g., a polymer) without significant transfer of embossable layer (e.g., polymeric) material from the disk onto the stamper 100. In addition, the perfluoropolyether coating 120 on the stamper 100 may also exhibit high temperature resistance and, thereby, enable repeated imprints of embossable films at elevated temperatures with effective surface 125 separation from an embossed disk without significant material transfer.

In the foregoing specification, the invention has been described with reference to specific exemplary embodiments thereof. It will, however, be evident that various modifications and changes may be made thereto without departing from the broader spirit and scope of the invention as set forth in the appended claims. The specification and figures are, accordingly, to be regarded in an illustrative rather than a restrictive sense.

What is claimed is:

1. A stamper, comprising:
a body; and
a perfluoropolyether polymer coating disposed on the body.

2. The stamper of claim 1, wherein the coating comprises functional perfluoropolyether polymers.

3. The stamper of claim 2, wherein molecules of the functional perfluoropolyether polymers are terminated by a hydroxyl.

4. The stamper of claim 2, wherein molecules of the functional perfluoropolyether polymers are terminated by a carboxyl.

5. The stamper of claim 2, wherein molecules of the functional perfluoropolyether polymers are terminated by an amine.

6. The stamper of claim 1, wherein the coating comprises difunctional perfluoropolyether polymers.

7. The stamper of claim 6, wherein molecules of the difunctional perfluoropolyether polymers are terminated by a hydroxyl.

8. The stamper of claim 6, wherein molecules of the difunctional perfluoropolyether polymers are terminated by a carboxyl.

9. The stamper of claim 6, wherein molecules of the difunctional perfluoropolyether polymers are terminated by an amine.

10. The stamper of claim 1, wherein the coating has a thickness in the range of approximately 10 to 25 Angstroms.

11. The stamper of claim 1, wherein the body comprises metal and has a patterned surface and wherein the coating is disposed on the patterned surface.

12. The stamper of claim 11, wherein the coating comprises functional perfluoropolyether polymers.

13. The stamper of claim 11, wherein the coating comprises difunctional perfluoropolyether polymers.

14. The stamper of claim 11, wherein the coating has a thickness in the range of approximately 10 to 25 Angstroms.

15. The stamper of claim 1, further comprising an oxide layer disposed between the body and the perfluoropolyether polymer coating.

16. The stamper of claim 15, wherein the oxide layer comprises SiO₂.

17. The stamper of claim 2, further comprising an oxide layer disposed between the body and the perfluoropolyether polymer coating.

18. The stamper of claim 3, further comprising an oxide layer disposed between the body and the perfluoropolyether polymer coating.

19. A method, comprising:
providing a stamper body having a surface; and
applying a polymerized fluorine compound above the surface of the stamper body.

20. The method of claim 19, wherein the fluorine compound is a perfluoropolyether polymer.

21. The method of claim 20, wherein applying comprises dip-coating.

22. The method of claim 20, wherein applying comprises chemical vapor deposition.

23. The method of claim 20, further comprising cleaning the surface of the stamper body prior to the applying of the polymerized fluorine compound.

24. The method of claim 23, wherein cleaning comprises cleaning the surface in an oxygen plasma.

25. The method of claim 20, further comprising curing the perfluoropolyether polymer.

26. The method of claim 25, wherein curing comprises heating the perfluoropolyether polymer.

27. The method of claim 26, wherein curing further comprises heating the perfluoropolyether polymer for a time in the range of approximately 10 to 60 minutes.

28. The method of claim 25, wherein curing comprises cooling the perfluoropolyether polymer to room temperature.

29. The method of claim 25, further comprising removing perfluoropolyether polymer that is unattached to the surface of the stamper body after curing.

30. The method of claim 29, wherein removing comprising rinsing with a fluorinated solvent.

31. The method of claim 20, wherein the stamper has a pattern of raised areas and recessed areas.

32. The method of claim 31, wherein the fluorine polymer is a perfluoropolyether polymer.

33. The method of claim 32, further comprising curing the perfluoropolyether polymer.

34. The method of claim 33, wherein curing comprises heating the perfluoropolyether polymer at a temperature in a range of approximately 100 to 250 degrees C.

35. The method of claim 34, wherein curing further comprises heating the perfluoropolyether polymer for a time in the range of approximately 10 to 60 minutes.

36. The method of claim 34, wherein curing comprises cooling the perfluoropolyether polymer.

37. The method of claim 19, further comprising depositing an oxide layer above the surface of the stamper body, wherein the oxide layer is disposed between the stamper body and the polymerized fluorine compound.

38. The method of claim 20, further comprising depositing an oxide layer above the surface of the stamper body, wherein the oxide layer is disposed between the stamper body and the polymerized fluorine compound.

39. An apparatus, comprising:
means for generating a discrete track recording pattern on an embossable layer of a disk; and
means for inhibiting material transfer from the embossable layer to the generating means.

40. The apparatus of claim 39, wherein the means for inhibiting comprises a low energy and low friction film.

41. The apparatus of claim 39, wherein the means for inhibiting comprises a high temperature resistant film.
